(19) United States
(12) Patent Application Publication
(10) Pub. No.: US 2023/0405860 A1
(43) Pub. Date: Dec. 21, 2023

(54) CONTROL SYSTEMS FOR POWER TOOLS

(71) Applicant: SawStop Holding LLC, Tualatin, OR (US)

(72) Inventors: Louis R. Slamka, Vancouver, WA (US); Keith P. Hebert, Lake Oswego, OR (US)

(73) Assignee: SawStop Holding LLC, Tualatin, OR (US)

(21) Appl. No.: 18/035,580

(22) PCT Filed: Nov. 5, 2021
(86) PCT No.: PCT/US2021/058178

§ 371 Date: May 5, 2023

Related U.S. Application Data
(60) Provisional application No. 63/110,691, filed on Nov. 6, 2020.

(51) Int. Cl. B26D 7/24; G05B 19/042

(52) U.S. Cl. CPC B26D 7/24; G05B 19/042; B27G 19/02

(57) ABSTRACT

Control systems for power tools such as table saws, miter saws, band saws, hand-held circular saws, jointers, shapers, routers, up-cut saws and other machinery are disclosed. The control systems are particularly relevant to power tools equipped with active injury mitigation technology, and to a set, collection, family, series, group or suite of different types of power tools.

### CROSS-REFERENCE TO RELATED APPLICATIONS

This application is a continuation of International Application No. PCT/US2021/058178, filed Nov. 5, 2021, which claims the benefit of and priority from U.S. Provisional Patent Application Ser. No. 63/110,691, filed Nov. 6, 2020, which is incorporated herein by reference.

### TECHNICAL FIELD

The present specification relates to control systems for power tools such as table saws, miter saws, band saws, hand-held circular saws, jointers, shapers, routers, up-cut saws and other machinery.

### BACKGROUND

Power tools such as table saws, miter saws, band saws, hand-held circular saws, jointers, shapers, routers, and up-cut saws are used to cut and shape material. In most power tools a user simply flips a switch to start the tool. The switch closes a circuit so that electric current flows through the switch to a motor, and the motor moves a blade or cutter.

Power tools with active injury mitigation technology are controlled differently. Active injury mitigation technology refers to technology that detects contact or proximity between a person and a spinning blade or cutter, and then performs some predetermined action to mitigate injury, such as stopping and/or retracting the blade or cutter. Exemplary implementations of active injury mitigation technology are described in International Patent Application Publication No. WO 01/26064 A2, which is incorporated herein by reference. Power tools with active injury mitigation technology typically include microprocessor-based control systems which monitor and control various conditions and functions of the power tool including inputs from a user or operator and control signals to stop and start the motor.

This specification describes improved systems to control the operation of power tools. The improved systems are particularly, but not exclusively, applicable to power tools with active injury mitigation technology. The improved systems, for example, provide compatibility for use in different types of power tools.

### BRIEF DESCRIPTION OF THE DRAWINGS

FIG. 1 shows a schematic view of a first power tool.

FIG. 2 shows a schematic view of a second power tool.

FIG. 3 shows a schematic view of a power tool with active injury mitigation technology.

FIG. 4 shows a schematic view of an alternative power tool with active injury mitigation technology.

FIG. 5 shows an isometric view of a power tool in the form of a compact, portable table saw.

FIG. 6 shows an isometric view of some of the internal components of the power tool of FIG. 5.

FIG. 7 shows an isometric view of some of the internal components of the power tool of FIG. 5.

FIG. 8 shows an isometric view of a power tool in the form of a jobsite table saw.

FIG. 9 shows an isometric view of a power tool in the form of a stationary table saw.

FIG. 10 shows an isometric view of a power tool in the form of a stationary band saw.

### STATEMENTS CONCERNING THIS DISCLOSURE

The present disclosure describes various exemplary embodiments of power tools, components, circuits and processes. The embodiments as disclosed and illustrated herein are not to be considered in a limiting sense as numerous variations are possible. Rather, the various exemplary embodiments depicted in the drawings and described in detail below are intended to illustrate specific examples and implementations in a variety of different contexts. It will be understood by those of skill in the art that many different variations, modifications, alternatives, and equivalents of these particular exemplary embodiments are possible. Therefore, the drawings and detailed description are not intended to limit the scope of the claims to the forms, arrangements, components, and/or configurations depicted and described therein. Instead, the drawings and detailed description are intended to cover all such variations, modifications, alternatives, and equivalents as are described and suggested within the scope and spirit of the disclosure and as are defined by the claims.

While references to “exemplary embodiment”, “alternative embodiments”, “other embodiments”, etc., may appear throughout the disclosure, repeated occurrences of such references are not intended necessarily to refer to the same embodiment(s). Rather, such references should be understood in the context in which they are provided and with reference to the figures and components with which they are associated within the narrative of the disclosure. Furthermore, reference to certain embodiments is not intended to exclude other embodiments since particular components, elements, circuits, structures, assemblies, processes, and methods described herein may be combined and/or modified in any manner that is suitable and consistent with the disclosure.

This disclosure may sometimes refer to structural elements as being “configured to,” or “adapted to,” perform one or more tasks, operations, or functions. Such elements may be referred to as “components,” “circuits,” “assemblies,” “mechanisms,” etc. It should be understood that when such an element is described as being “configured to” or “adapted to” perform such a task or etc., this phrasing is intended to refer to a physical object or structure such as an electronic component (e.g., resistor, capacitor, cable, processor, etc.), or a mechanical component (e.g., arm, bracket, shaft, mount, housing, etc.), or a plurality of such components interconnected or combined into a circuit, mechanism or assembly. Furthermore, the phrasing “configured to” or “adapted to” perform a particular task is intended to indicate that the structural component or combination of components is arranged, positioned, selected, programmed, connected, combined and/or designed to perform the particular function stated. Thus, for example, the phrase “a processor component configured to receive an input from a user-input component” means a physical processor with one or more input nodes which may be connected either directly, or indirectly through additional circuit components, to the output of a physical switch, button, knob or similar component which is operable by a person to produce electrical signals. And further that the input node(s) of the processor are capable of receiving signals of the type which the user-input component produces, so that the processor, while executing software instructions stored in memory is capable of recognizing the signal for its intended purpose and executing further instructions in response to the signal as determined by the stored software. Likewise, the phrase “a motor configured to drive the cutting tool” means a motor with sufficient output power to move the cutting tool in a manner and at a speed appropriate for the corresponding power tool to cut or shape workpieces as intended. Therefore, it should be understood that all references herein of some particular element being “configured to” or “adapted to” perform some operation, task, or function refers to a physical object and not to some intangible entity, process, or function.

In addition, the term “configured to” or “adapted to” does not mean “configurable to” or “adaptable to.” Thus, for example, an unprogrammed processor that is devoid of executable software instructions may be configurable to perform a task, but it cannot be considered as “configured to” perform the task. Instead, if a processor is referred to herein as “configured to” perform a task, that means the processor includes the necessary executable software instructions, as well as any necessary processing functionality such as analog-to-digital conversion or etc., to perform the referenced task.

To the extent the phrase “in response to” is used herein, the phrase is intended to describe one more factors that produce an effect. However, the phrase is not intended to eliminate the possibility that additional and/or different factors may affect whether or how the effect is produced. Thus, for example, the phrase “the control circuit is configured to start the motor in response to inputs by the operator” does not mean that the input from the operator is necessarily the only input or condition necessary to start the motor. Instead, the phrase is intended to cover the situation where the motor is started solely in response to input by the operator, as well as the situation where the motor is started only when one or more additional conditions or inputs are present in combination with the input by the operator. Furthermore, the phrase is also not intended to convey that the motor can only be started in response to the input from the operator, as other conditions and/or inputs may also cause the motor to start independent of the input from the operator.

If used herein, the terms “first,” “second,” etc., when used to modify structural elements, are not intended to describe any temporal or spatial order or priority, unless such order or priority is expressly stated. Thus, for example, the terms “first processor” and “second processor” do not, unless otherwise stated, imply that the component referred to as the “first processor” has any priority or control over the component referred to as the “second processor.” Furthermore, the terms are not intended to imply that the two processors are either identical or non-identical unless explicitly described as such. Instead, the terms are solely intended to convey the presence of two, separate physical processors.

Unless otherwise stated explicitly, the terms “user” and “operator,” when used herein in reference to using or operating a mechanism such as a power tool, are identical and interchangeable. In contrast, the term “person” means any person whether or not the person is using or operating the mechanism in question.

In the drawings and description herein, numerous specific details are disclosed for a variety of exemplary embodiments to provide a complete and thorough understanding to those of skill in the art. Nevertheless, those of skill in the art will recognize that many aspects of the present disclosure can be practiced without one or more of the specific details. In some embodiments, well-known and/or readily available components, circuits, structures, assemblies, signals, software instructions, and techniques may have not been shown in detail to avoid unhelpful complexity which might hinder comprehension of the present disclosure in its entirety.

### DETAILED DESCRIPTION

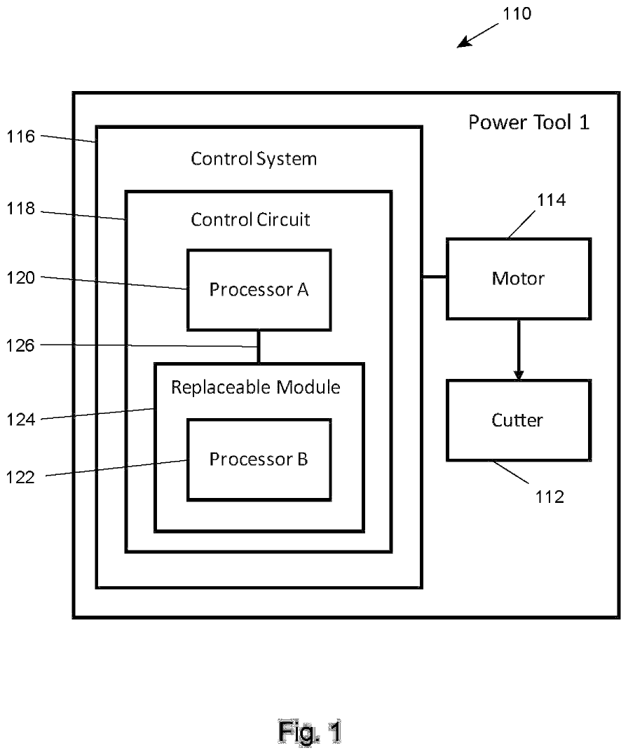

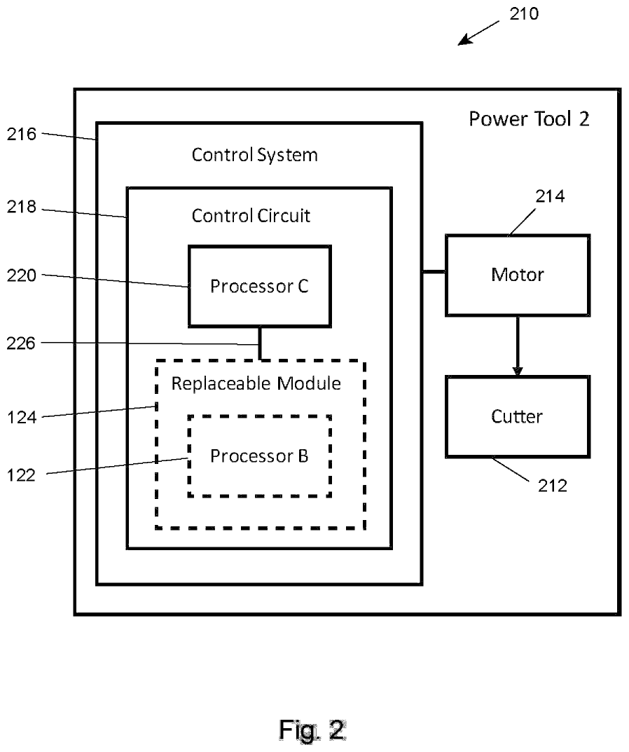

Two exemplary embodiments of a power tool according to the present invention are shown schematically at 110 in FIG. 1 and at 210 in FIG. 2. It will be understood by those of skill in the art that power tools 110 and 210 can be any of a wide variety of well-known electro-mechanical devices designed to process workpieces of various materials. As used herein, woodworking machinery describes power tools designed primarily to cut wood, although woodworking machinery is sometimes used to cut other materials such as plastic and aluminum. Some common examples of woodworking machinery are table saws, band saws, miter saws, hand-held circular saws, up-cut saws, jointers, routers, shapers, etc.

As will be described in more detail below, power tool 110 is a first type of power tool while power tool 210 is a second type of power tool that is different than the first type. As used herein, power tools of different types are power tools having one or more functional differences which may or may not be readily apparent to the user or operator of the power tool. For example, power tool 110 may be a portable table saw with a plastic housing, while power tool 210 may be a portable table saw with an open-frame. Alternatively, power tools 110 and 210 may have similar external features and structures but have slightly different motors with different electrical input or output power characteristics. Alternatively, power tool 110 could be a small portable table saw while power tool 210 could be a large, stationary table saw. As a further example, power tool 110 could be a table saw while power tool 210 could be a different category of power tool such as a band saw, a miter saw, or any of the other well-known power tools. Although just a few illustrative examples of different power tool types are described above, it will be understood that many other combinations of different types of power tools are within the scope of the present invention.

While different types of power tools have one or more functional differences which distinguish them as being of different types, there are also one or more similarities that are typical of power tools according to the present invention. Thus, exemplary power tool 110 includes a cutting tool or cutter 112 adapted to cut a workpiece when moving, and a motor 114 configured to drive or move cutter 112. Power tool 110 also includes a control system 116 configured to monitor and control one or more functions of power tool 110 including operation of motor 114. Similarly, exemplary power tool 210 includes a cutting tool or cutter 212 adapted to cut a workpiece when moving, and a motor 214 configured to drive or move cutter 212. Power tool 210 likewise includes a control system 216 configured to monitor and control one or more functions of power tool 210 including operation of motor 214.

It will be appreciated that cutter 112 may be the same as, or different than, cutter 212. As one example, cutter 112 may be a circular blade with teeth spaced about the perimeter, while cutter 212 could be a band-shaped blade with teeth spaced along one edge of the band. Alternatively, one or both of cutters 112 and 212 could be in the form of a bit, chipper, shaper, or etc. Furthermore, cutters 112 and 212 may have similar forms, such as a circular blade, but have different diameters and/or thicknesses. Thus, it will be understood that cutters 112 and 212 may be any of the well-known cutting tools adapted for use on power tools to remove material from workpieces. Likewise, motor 114 may be the same as, or different than, motor 214. The motors may be any of the well-known types of motors suitable for use in a power tool including, induction motors, universal motors, DC motors, brushless motors, etc.

Regardless of whether the functional difference or differences between power tool 110 and power tool 210 include the cutters and/or the motors, it will be appreciated that the functional differences between different types of power tools will often prompt differences in the control systems of the respective power tools. In other words, power tools of different types will typically have different control systems. These may be differences in the hardware and/or the software of the control systems. For example, the control system of a power tool with an induction motor operating at 230V may have different switching components to supply electrical power to the motor than the control system of a power tool with a universal motor operating at 110V. As another example, the control system of a table saw may have a different user interface and/or operational sequence than the control system of a band saw. Similarly, the control system of a battery-operated power tool may include power regulation circuitry and software that is different than those of the control system for a power tool that is connected to a wall electrical socket. As another example, the motor of one type of power tool may run at a different speed than the motor of another type of power tool, thereby requiring different components and/or software computations to monitor or predict the speed of the motor, the arbor, or the cutter.

As used herein, control systems for power tools are comprised of various mechanical, electronic hardware and software elements that are assembled, arranged, connected and configured to monitor and control various functions of the power tool. Furthermore, such control systems may include user-interface components to enable a person to operate or control the functions of the power tool. Such user-interface components may include one or more knobs, buttons, switches, levers, triggers, keypads, keyboards, etc., that allow an operator to input signals to the control system. In some embodiments, the user-interface components may include lights, LEDs, displays, or similar human-perceivable indicating elements to communicate selected status and/or error conditions of the power tool to the operator.

It will be appreciated that the functions and conditions of the power tool that may be monitored and controlled by and through the control system are numerous and varied depending on the type of power tool. For example, control systems may simply start and stop the motor, or may additionally control and/or monitor the motor speed including ramp up speed, operating speed and/or coast down speed. Some control systems may monitor ambient temperature or motor input/output power. Additionally, operating time, cutter position, cutter size, motor torque, maintenance intervals, incoming power levels and frequencies, and guard positions are just a few additional examples of the many different power tool functions and conditions that may be monitored and/or controlled by power tool control systems according to the present invention. A few exemplary embodiments of control systems are described in more detail in U.S. Pat. Nos. 7,971,613, 10,384,281 and 10,442,107, and in U.S. Provisional Patent Application Ser. No. 63/051,402, the disclosures of which are incorporated herein by reference in their entireties.

Focusing now on the exemplary embodiment of FIG. 1, it will be seen that control system 116 includes a control circuit indicated schematically at 118. Control circuit 118 includes a plurality of electronic, electrical and/or electromechanical components that are connected, arranged and configured to interact and communicate with each other as well as one or more components of the power tool outside the control system. Examples of power tool control circuits are described in more detail in the references incorporated herein above and below. Exemplary control circuit 118 includes a micro-processor indicated at 120 and designated in the schematic as Processor A. Control circuit 118 also includes another micro-processor indicated at 122 and designated in the schematic as Processor B. It will be understood that the term processors, as used herein, may be any of the well-known and widely available electronic processors configured to store software or program code and to execute instructions contained within the software to send and receive analog and/or digital signals via multiple input and/or output ports, and perform various internal functions such as computations, conversions between analog and digital signals, signal processing, and etc. Processors 120 and 122 may be the same processors or different processors having different capabilities and features.

In the exemplary embodiment of FIG. 1, processor B is contained within a replaceable module that is configured to be mounted or installed onto power tool 110 by a user or operator of the power tool. Typically, though not necessarily, replaceable module 124 is configured to be installed and uninstalled, or mounted and unmounted, on the power tool without the use of tools. In any case, when replaceable module 124 is installed on power tool 110, a physical communications connection 126 is established between the replaceable module and processor A so that processor A and processor B can communicate electronically. Thus, it will be understood that power tool 110 and control circuit 118 are configured to receive and connect to processor B when the replaceable module is installed on power tool 110.

Once replaceable module 124 is installed on power tool 110 and connected to control circuit 118 and processor 120, electrical power can be supplied by the control circuit to processor 122, thereby enabling operation of processor 122. As a result, the replaceable module becomes an operational component of control system 116 and control circuit 118, and thus the replaceable module can also be thought of as a replaceable control module. Furthermore, processors 120 and 122 are configured and programmed to communicate with one another and to operate separately and/or cooperatively to control and monitor the various functions and conditions of the power tool as discussed above. Thus, when replaceable module 124 is removed or uninstalled from power tool 110, it will be appreciated that at least some functions and/or conditions of the power tool will not be monitored or controlled by control system 116. In the exemplary embodiment of FIG. 1, control system 116 is configured to prevent operation of the power tool, by disabling operation of motor 114, when replaceable module 124 is not installed. However, it is within the scope of the invention for alternative embodiments of a power tool and control system to allow limited operation of the power tool, or operation of the power tool with somewhat reduced functionality.

It will be appreciated that positioning processor B in replaceable module 124 provides numerous advantages as a result of enabling the operator to uninstall the replaceable module from the power tool. For example, if the control system is configured to prevent operation of the power tool when replaceable module 124 is not installed, then the operator can prevent an unauthorized user from operating the power tool by removing the replaceable module. Alternatively, if different types of replaceable modules are available having different features, then the operator could enable these different features by removing one replaceable module and installing a different replaceable module with the desired features. Even if such a replacement module does not offer different features, it may contain updated or improved software in the processor contained therein. Alternatively, an operator with multiple power tools could share a single replaceable module among the power tools, thereby reducing cost. Furthermore, different replaceable modules may be configured for use with different cutters, thereby allowing an operator to selectively switch between different cutters by switching the replaceable modules. For example, it is well-known in the art for table saws with active injury mitigation (hereinafter referred to as AIM) technology to use different replaceable modules for standard 10 inch saw blades and 8 inch dado blade sets. Exemplary embodiments of such power tools will be described in more detail below.

It will be appreciated that since replaceable module 124 can be uninstalled and reinstalled on power tool 110, the replaceable module can likewise be uninstalled from power tool 110 and then installed on a different power tool that is configured to receive the replaceable module. Turning attention back to FIG. 2, power tool 210 is one exemplary embodiment of such a different power tool. As discussed above, power tool 210 includes a cutter 212 that is driven or moved by a motor 214. Power tool 210 also includes a control system 216 configured to control operation of motor 214. As also discussed above, power tool 210 is a different type of power tool than power tool 110 shown in FIG. 1. As a result, control system 216 is different than control system 116 in that control system 216 includes a different control circuit 218 having a processor 220 which is designated in the schematic as Processor C.

It will be understood that Processor C (220) of control circuit 218 is different than Processor A (120) of control circuit 118. In some embodiments, Processor C may be a different physical microprocessor chip with different features and capabilities than the physical microprocessor chip of Processor A, while other embodiments of power tool 210 and control circuit 218 may utilize the identical physical microprocessor chip as Processor A. The selection of the physical microprocessor chip for Processors A and C will depend, at least partially, on the power tool functions and conditions which the respective control systems are intended to monitor and control. In any event, the software code stored within and executed by Processor C is different that the software stored and executed by Processor A. In other words, the software stored and executed by Processor C is customized for the type of power tool of which power tool 210 is a specimen. In contrast, the software stored and executed by Processor A is customized for the type of power tool of which power tool 110 is a specimen.

Similar to power tool 110, power tool 210 of FIG. 2 is configured to receive and support replaceable module 124 so that the replaceable module connects to control circuit 218. When replaceable module 124 is installed on power tool 210 and connected to control circuit 218, a physical communications connection 226 is established between the replaceable module and processor 220 so that processor 220 and processor 122 can communicate electronically. Furthermore, electrical power can be supplied by control circuit 218 to processor 122, thereby enabling operation of processor 122. Thus, when replaceable module 124 is installed on power tool 210, the replaceable module becomes an operational component of control system 216 and control circuit 218.

Processors 220 and 122 are configured and programmed to communicate with one another and to operate separately and/or cooperatively to control and monitor the various functions and conditions of the power tool as discussed above. Thus, when replaceable module 124 is removed or uninstalled from power tool 210, it will be appreciated that at least some functions and/or conditions of the power tool will not be monitored or controlled by control system 216. In the exemplary embodiment of FIG. 2, control system 216 is configured to prevent operation of the power tool, by disabling operation of motor 214, when replaceable module 124 is not installed.

As discussed above, power tool 210 is a different type of power tool than power tool 110. Therefore, there are one or more functional differences between power tool 210 and power tool 110. Such functional difference or differences requires a modification in the behavior of processor 122 when replaceable module 124 is installed in power tool 210 as compared to when the replaceable module is installed in power tool 110. As just one example, the control systems of power tools 110 and 210 may be configured to monitor ramp up and no-load speed of the respective motors. If power tool 210 has a different motor than power tool 110, it will be appreciated that the expected performance of the two types of motors will be different. In other words, motor 114 may have a different nominal operating range than motor 214. As a result, any error thresholds for motor operation would be different for motor 114 and motor 214, and control system 116 would be configured to recognize an error condition at different thresholds than control system 216. It will be understood that this example of monitoring motor speed is intended as just one exemplary illustration. Any of the other functional differences between different types of power tools, such as described herein and in the incorporated references, and such as are well-known to those of skill in the art, are within the scope of the present invention.

When monitoring or controlling a particular power tool function or condition is either partially or wholly assigned by the control systems 116 and 216 to processor 122, then it will be appreciated that the operation of processor 122 may necessarily be different depending on whether replaceable module 124, and thus processor 122, is installed on power tool 110 or power tool 210. Therefore, it is desirable that the software stored and executed by processor 122 is configured to operate differently when the replaceable module is installed on different types of power tools. Furthermore, it is desirable for the control system to enable processor 122 to determine which type of power tool the replaceable module is installed in.

Control systems according to the present invention enable processor 122 to determine which type of power tools the control systems are part of by communicating the power tool type to processor 122 when the replaceable module is installed on the power tool. In the exemplary embodiment shown in FIG. 1, processor 120 of control system 118 is configured to store digital information identifying the type of power tool 110. Alternatively, or additionally, processor 120 is configured to store digital information identifying the configuration or type of control system 116, which is adapted for use in power tool 110. In any event, when replaceable module 124 is installed on power tool 110 and the communications connection 126 is established between processor 120 and the replaceable module, processor 120 is configured to communicate the information identifying the type of power tool 110 to processor 122. Furthermore, processor 122 is configured to receive this information and execute the software stored by processor 122 that is configured for controlling and or monitoring selected condition and functions of power tool 110.

Similarly, exemplary processor 220 of control system 216 is also configured to store digital information identifying the type of power tool 210. Alternatively, or additionally, processor 220 is configured to store digital information identifying the configuration or type of control system 216, which is adapted for use in power tool 210. In any event, when replaceable module 124 is installed on power tool 210 and the communications connection 226 is established between processor 220 and the replaceable module, processor 220 is configured to communicate the information identifying the type of power tool 210 to processor 122. Furthermore, processor 122 is configured to receive this information and execute the software stored by processor 122 that is configured for controlling and or monitoring selected conditions and functions of power tool 210.

It will be understood that the information identifying the power tool types, which is stored by both processors 120 and 220, may be communicated to processor 122 by any of the well-known methods and formats for communicating digital information between processors. In the exemplary embodiments of power tools 110 and 210, processors 120, 220 and 122 include well-known Universal Asynchronous Receiver/Transmitter (UART) circuitry for communicating digital information over the communication connections 126 and 226, respectively. In alternative embodiments, the UART circuitry can be external to one or more of the processors rather than on-board the processors. In any event, processors 120 and 220 are each configured to transmit the identifying information as part of communication packets of digital information transmitted to processor 122 via the UART circuitry. Thus, control systems 116 and 216 inform processor 122 of the particular type of the power tool that replaceable module 124 is installed in so that processor 122 can operate as desired and configured for that particular power tool type.

It will be appreciated that, looking at power tools 110 and 210 simultaneously, one aspect of the present invention is a system or set of power tools of different types. Each type of power tool is configured with certain conditions and functions that are particular to that type of power tool. Some of the functions and conditions may be shared between certain power tool types, but each type of power tool within the system or set will have at least one function or condition that is not shared with, or is different than, the functions and conditions of the other types of power tools within the set. The set of different power tools may also be thought of a collection, family, series, group or suite of different types of power tools. In any event, each type of power tool is configured to accept a common replaceable module with a processor configured to connect to and operate as a component of the different control systems of the different power tool types. In other words, replaceable module 124 and processor 122 are configured to operate as a component of multiple different types of power tools and power tool control systems.

It will be appreciated that a set of different types of power tools that are operable with a single replaceable module has many advantages. Since the replaceable module is interoperable among the different types of power tools, a user who only operates one power tool at a time can purchase a single replaceable module for use with multiple types of power tools. Similarly, a user who owns multiple power tool types can move the replaceable module from a first type of power tool to a second type of power tool, or vice versa, if the replaceable module of one power tool becomes unusable or lost, etc. Furthermore, the communication of the particular power tool type by the control system to the replaceable module allows the software in processor 122 to be configured with differing software routines or portions of routines that are specific for each different power tool type. Thus, it is not necessary to make compromises in the operation of processor 122 to enable compatibility among different power tool types.

Another way of understanding the exemplary control systems of FIGS. 1 and 2, is that each control system includes a first portion that is customized or adapted to one particular type of power tool in a set of different types of power tools, and a second portion that is adapted to be common, universal or generic to all the different types of power tools within the set. The first portion includes a processor that is configured and programmed for optimal operation on the particular type of power tool that it is installed on. This portion of the control system is not intended to be uninstalled from the power tool and is not adapted to operate as a component of a different type of power tool or control system. Conversely, the second portion includes a processor that is configured and programmed to operate, cooperatively with the processor in the first portion, as a component in different types of power tools and control systems. Furthermore, the processor in the second portion is configured to operate differently depending on which type of power tool it is installed in. This enables the control system of each type of power tool to optimally control and monitor the power tool in which it is installed and a part of. Additionally, the processor in the second portion is configured to be uninstalled from one type of power tool within the set and then reinstalled in a different type of power tool within the set, where the uninstallation and installation are accomplished by the operator or user of the power tool.

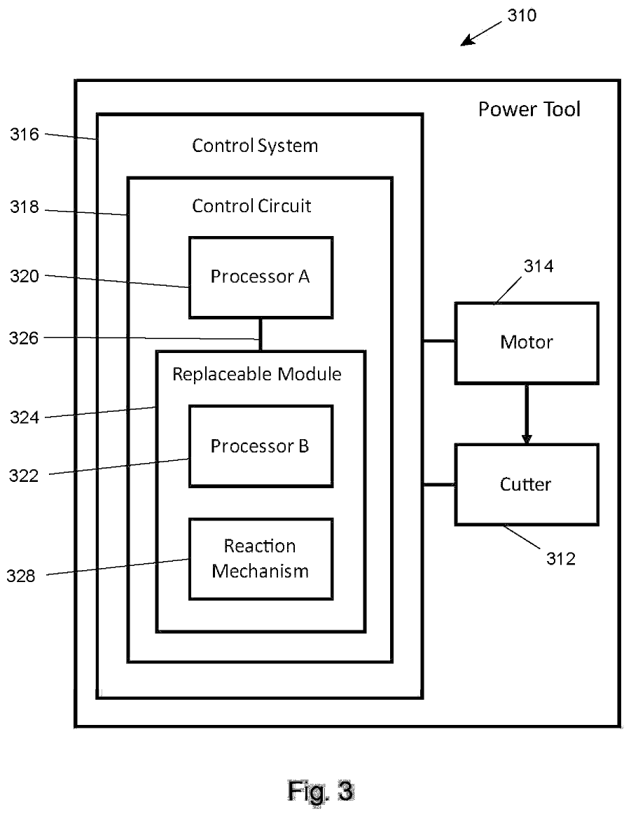

It will be appreciated that the control systems according to the present invention offer substantial benefits over the prior art. One example of such benefits is manifested for sets of power tool types, all of which incorporate AIM technology. One exemplary embodiment of such a power tool is shown schematically in FIG. 3 and indicated generally at 310. Similar to exemplary power tools 110 and 210, exemplary power tool 310 includes a cutting tool or cutter 312 adapted to cut a workpiece when moving, and a motor 314 configured to drive or move cutter 312. Power tool 310 also includes a control system 316 configured to monitor and control one or more functions of power tool 310 including operation of motor 314.

Control system 316 also includes AIM technology. It will be understood by those of skill in the art that AIM technology or an AIM system, refers any one of a variety of electrical and mechanical structures arranged, assembled, connected, coupled, adapted and/or configured to detect the occurrence of a potentially dangerous condition and thereupon to react or initiate a reaction to mitigate injury to a user, operator or other person in proximity to the table saw. An AIM system is different than a passive injury mitigation system, such as a blade guard, in that a passive injury mitigation system does not detect the occurrence of a potentially dangerous condition and does not react or initiate a reaction to the potentially dangerous condition. Examples of AIM systems are disclosed in International Patent Application No. PCT/US00/26812, published as International Publication No. WO 01/26064 A2 on Apr. 12, 2001, the disclosure of which is incorporated herein by reference in its entirety.

As is well-known and extensively described in the art, AIM systems can be configured in a wide variety of ways to actively mitigate injury in the event of a dangerous condition such as the operator of a power tool or a bystander accidentally contacting the cutter when the cutter is moving. Alternative AIM systems may be configured to mitigate injury in response to other dangerous conditions such as dangerous proximity to the moving cutter, kickback, etc. Furthermore, AIM systems may be configured to mitigate injury in response to multiple dangerous conditions rather than a single dangerous condition.

In the exemplary embodiment of an AIM system which is adapted to mitigate injury in the event of accidental contact with the cutter, the AIM will system typically include electronic circuitry which may be interconnected with mechanical components that electrically couple the circuitry to the cutter. Such circuitry often includes one or more processors that are programmed to monitor electrical signals from the cutter and perform various analyses and computations to determine if a dangerous condition has occurred, such as when a person contacts the cutter when the cutter is moving. These combinations and configurations of software, electronic circuitry and mechanical components are often referred to generally as detection systems since the combinations are configured to detect accidental contact between a person and the cutter. Thus, the phrase “detection system” is understood to identify a category of structural and software components. A few exemplary embodiments of detections systems are described in more detail in International Patent Application No. PCT/US00/26812, published as International Publication No. WO 01/26064 A2 on Apr. 12, 2001, U.S. Pat. No. 7,900,541 issued Mar. 8, 2011, U.S. Pat. No. 7,971,613 issued Jul. 5, 2011, U.S. Pat. No. 8,498,732 issued Jul. 16, 2013, and International Patent Application No. PCT/US2017/034566, published as International Publication No. WO 2017/210091 A1 on Dec. 7, 2017, the disclosures of which are incorporated herein by reference in their entireties.

Additionally, such AIM systems typically include combinations of electronic, mechanical and/or chemical components that are configured to take or initiate some action to mitigate injury if accidental contact is detected by the detection system. Examples of such actions include stopping the movement of the cutter, moving the cutter away from the point of accidental contact, etc. The well-known mechanisms for achieving such action are varied and include triggering a force generating mechanism such as a spring or explosive device to push a brake component into the cutter and/or move the cutter away from the point of accidental contact. Furthermore, some AIM systems are configured to take multiple actions to minimize injury. In any event, such combinations are often generally referred to as reaction systems since the combinations are configured to react to mitigate injury when a dangerous condition is detected by the detection system. Thus, the phrase “reaction system” is understood to identify a category of structural components. A few exemplary embodiments of reaction systems are described in more detail in International Patent Application No. PCT/US00/26812, published as International Publication No. WO 01/26064 A2 on Apr. 12, 2001, International Patent Application No. PCT/US2010/002634, published as International Publication No. WO 11/040957 on Apr. 7, 2011, U.S. Pat. No. 9,927,796 issued Mar. 27, 2018, U.S. Pat. No. 10,052,786 issued Aug. 21, 2018, and U.S. Pat. No. 10,442,107 issued Oct. 15, 2019, the disclosures of which are incorporated herein by reference in their entireties.

In the exemplary embodiment shown in FIG. 3, control system 316 includes a control circuit 318 with a first processor 320, designated in the schematic as Processor A, and a second processor 322, designated in the schematic as Processor B. As shown in FIG. 3, processor 320 is contained within a replaceable module 324 that is received by and connects to control circuit 318 so that processor 322 becomes an operational component of control circuit 318 and control system 316. Processor 322 is configured to communicate with processor 320 via a communications connection 326 that links replaceable module 324 to control circuit 318 and processor 320 when the replaceable module is installed on power tool 310. For example, processor 320 is configured to store digital information identifying the type of power tool 310, and to communicate that information to processor 322. Thus, it will be understood that control system 316 is similar in some respects to control system 116 as was shown in FIG. 1 and described in detail above.

However, as previously noted exemplary control system 316 includes AIM technology including a reaction mechanism indicated at 328. This exemplary reaction mechanism is configured to initiate an action to stop cutter 312 from cutting by stopping the movement of the cutter or retracting the cutter. As discussed above, alternative and/or additional reaction mechanisms are possible within the scope of the invention. As can be seen in FIG. 3, exemplary reaction mechanism 328 is contained within replaceable module 324. There are a number of reasons and advantages for placing the reaction mechanism inside the replaceable module. As one example, some reaction mechanisms include components that can only be used one time. Examples of such single-use components include fuse wires, deformable brakes, explosive cartridges, etc. Thus, placing the reaction mechanism inside the replaceable module allows the reaction mechanism to be replaced once it has been used or expended. In other words, the control system with the AIM technology can be restored to full functionality after an activation of the reaction mechanism by simply installing a new replaceable module on the power tool. Alternatively, the single use component may be repaired or replaced in the replaceable module to allow the replaceable module to be reused. An alternative or additional advantage is that processor 322 may be configured to store data associated with the detection of the dangerous condition and/or the activation of the reaction mechanism. In such case, the replaceable module may be returned to a service location where the data can be evaluated and analyzed to study the performance of the particular AIM technology incorporated into the control system. While these are a few advantages realized by placing reaction mechanism 328 in replaceable module 324, it will be appreciated that many other advantages are possible within the scope of the invention.

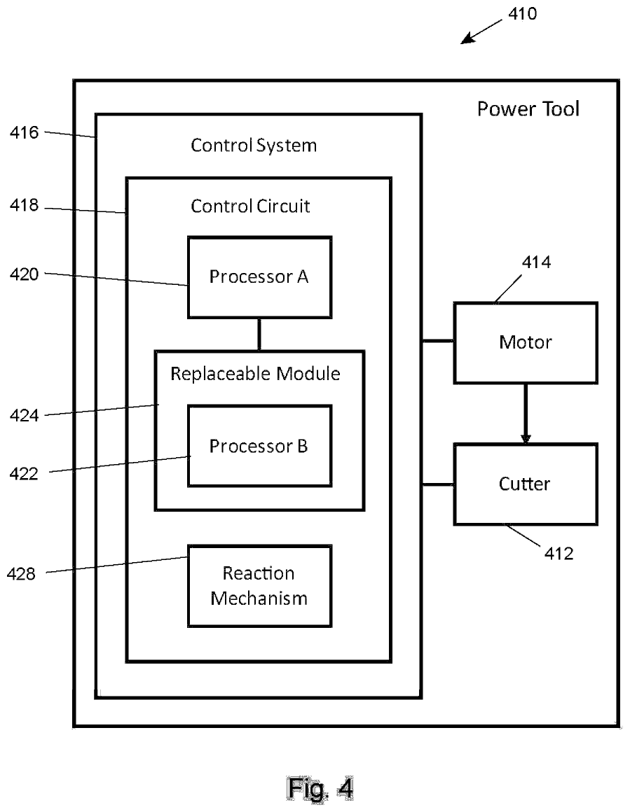

Although reaction mechanism 328 of the exemplary embodiment of FIG. 3 is schematically shown as fully contained within replaceable module 324, it will be understood that alternative embodiments are possible within the scope of the present invention. For example, a portion of the reaction mechanism may be contained within the replaceable module while the remainder of the reaction mechanism may be external to the replaceable module. As a further alternative, the entire reaction mechanism may be external to the replaceable module. An example of this alternative embodiment is shown schematically in FIG. 4.

Exemplary power tool 410 is generally similar to power tool 310 in that power tool 410 includes a cutter 412 driven by a motor 414. Power tool 410 also includes a control system 416 that incorporates AIM technology. Control system 416 includes a control circuit 418 having a processor 420 that is designated in the schematic as Processor A. Control circuit 418 also includes a processor 422 that is designated in the schematic as Processor B, and which is contained within a replaceable module 424. Control circuit 418 also includes a reaction mechanism 428 configured to stop cutter 412 from cutting. However, in contrast to the exemplary embodiment of FIG. 3, the reaction mechanism of the exemplary embodiment of FIG. 4 is external to replaceable module 424. It will be appreciated that there are a number of reasons and advantages for locating the reaction mechanism external to the replaceable module. For example, in embodiments of reaction mechanism which do not utilize single-use components, there may be no reason to replace the reaction mechanism after it has be activated. Such reaction mechanisms are often resettable in that the mechanism can be reset to activate multiple times. One example of such a resettable system is described in more detail in U.S. Pat. No. 10,384,281, the disclosure of which is herein incorporated by reference in its entirety. Nevertheless, the benefits of the replaceable module as described in the various embodiments above still remain.

It will be appreciated that control systems which include or incorporate AIM technology may implement or provide that technology in different ways depending on the type of power tool and the AIM technology that is adopted. For example, some embodiments may use the replaceable module to implement all or substantially all of the AIM technology. Such a configuration enables an operator to move the AIM technology enabled replaceable module from one type of power tool to another. In alternative embodiments, substantial portions of the AIM technology may reside external to the replaceable module. This latter configuration may be beneficial for sets or families of different power tool types where the reaction mechanism on one type of power tool is different than the reaction mechanism on another type of power tool. In such case, the replaceable module may implement aspects of the AIM technology which are universal between power tool types such as the detection of dangerous conditions and/or storage of data associated with the detection and/or reaction by the AIM system.

While the exemplary embodiments shown in FIGS. 1-4 depict control systems with two processors, it will be appreciated that control systems with more than two processors are also within the scope of the present invention. For example, it may be desirable to provide one or more additional processors within the control system, internal and/or external to the replaceable module, and/or it may be desirable to provide one or more additional processors outside the control system. In any event, all such alternatives are within the scope of the present invention.

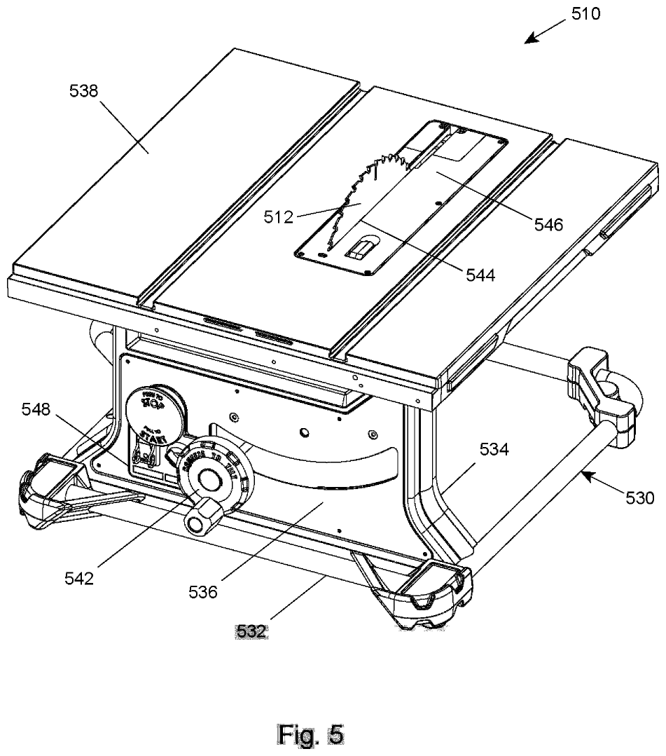

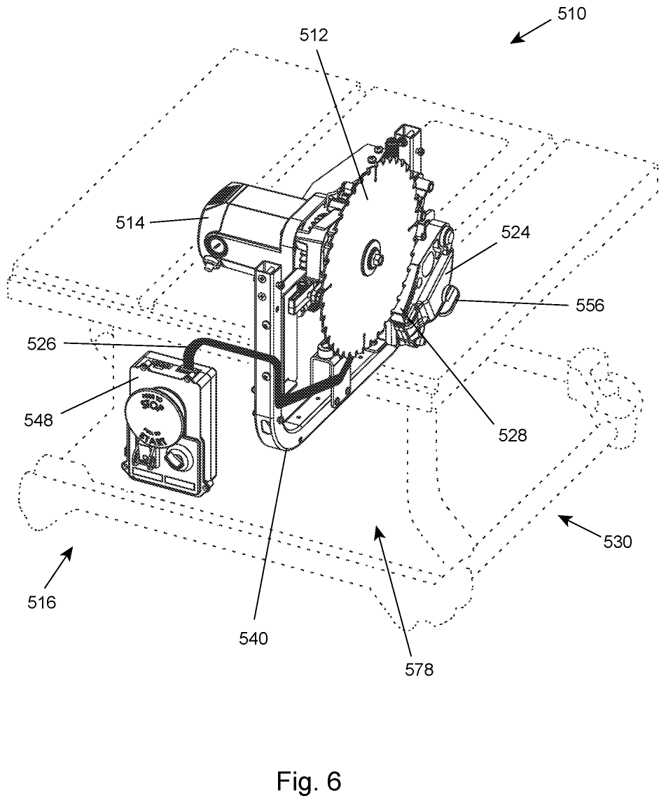

Turning attention now to FIGS. 5, 6 and 7, one particular exemplary power tool according to the present invention is indicated generally at 510. Power tool 510 is one type of power tool referred to herein as a compact, portable table saw. Table saw 510 is relatively small and lightweight compared to some other types of table saws and is suitable to be carried by a person to a worksite. Table saw 510 includes a support structure 530 in the form of an open frame assembly of metal tubing 532 welded to metal brackets at the front and rear of the saw, one front bracket being identified at 534. Support structure 530 also includes one or more panel members 536 attached to brackets 534 and at least partially covering some areas of the frame assembly. Table saw 510 also includes a workpiece support surface 538 in the form of a die-cast aluminum table that is mounted to, and supported by, support structure 530 and brackets 534.

Table saw 510 includes a cutter 512 in the form of a 10 inch circular saw blade that is mounted on the output shaft or arbor of a universal motor 514. Motor 514 is mounted to a trunnion assembly 540 that forms a movable part of support structure 530. Trunnion assembly 540 is configured to tilt relative to the table to enable the saw blade to be positioned at an angle relative to the table. Trunnion assembly 540 includes one or more controls such as control handwheel 542 that are configured to tilt the blade and/or change the elevation of the blade relative to the table. Using the control handwheel, an operator can adjust the position of the blade from fully below the table to partially above the table. When the blade is raised to a position partially above the table, the blade protrudes through a slot 544 in a removable table insert assembly 546. The support structure, table and trunnion assembly of table saw 510 are described in more detail in U.S. Provisional Patent Application Nos. 62/972,470 and 63/051,367, and in International Patent Application PCT/US2021/17258, filed Feb. 9, 2021, which claims priority to U.S. Provisional Patent Application Nos. 62/972,470 and 63/051,367, the disclosures of which are all incorporated herein by reference in their entireties.

Table saw 510 also includes a control system, indicated generally at 516, according to the present invention. The control system includes a control circuit, indicated generally at 518 with a first processor (not shown) mounted on a pc board that is contained in a stationary module or housing 548. Stationary housing 548 is in the form of a switchbox such as is described in more detail in International Patent Application PCT/US2021/41394, filed Jul. 13, 2021, which claims priority to U.S. Provisional Patent Application Ser. No. 63/051,402, the disclosures of which are incorporated herein by reference in their entireties. The switchbox is connected to electrical power through an electrical cord and also to motor 514 through a motor power cord. The control system controls operation of the motor by connecting and disconnecting the motor to electrical power.

The switchbox is also connected to a replaceable module 524 by an electrical ribbon cable 526. Replaceable module 524 is in the form of a brake cartridge, such as is described in described in more detail in U.S. Pat. No. 7,350,445, the disclosure of which is incorporated herein by reference in its entirety. Brake cartridge 524 includes a second processor (not shown) that is configured to communicate with the processor in switchbox 548 via the ribbon cable 526. Brake cartridge 524 also includes a reaction mechanism 528 in the form of a spring-actuated brake pawl that is configured to pivot into the teeth of saw blade 512 and stop the rotation of the blade. Trunnion assembly 540 is configured to allow blade 512 to pivot or retract downward below table 538 under the influence of the angular momentum impulse that is generated by stopping the blade. Thus, it will be understood that control system 516 includes AIM technology.

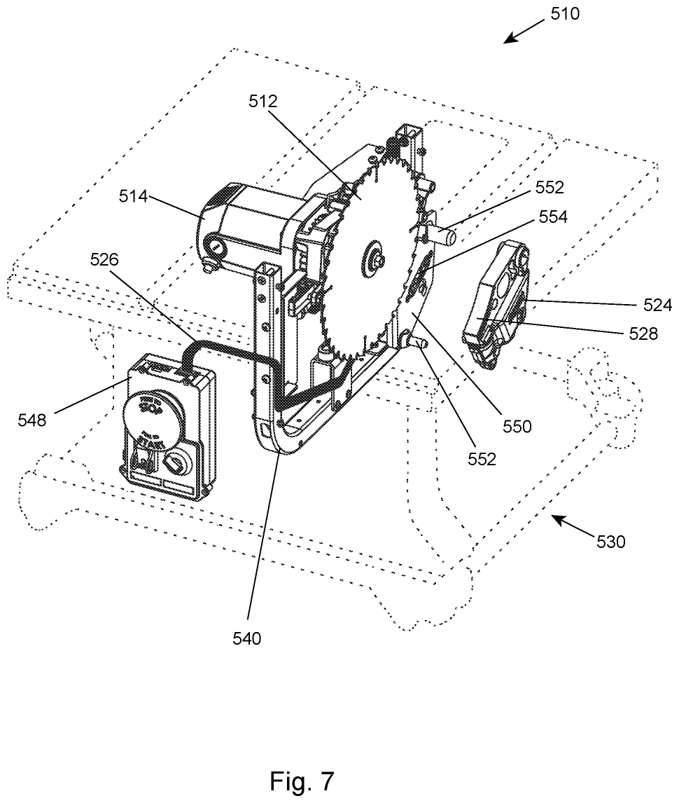

Referring also now to FIG. 7, replaceable module 524 is shown removed from support structure 530 and power tool 510. As can be seen in FIG. 7, trunnion assembly 540 includes a brake cartridge mounting component 550 in the form of a cartridge bracket assembly with mounting pins 552 that engage with sockets in brake cartridge 524 to hold the cartridge in place. The cartridge bracket assembly also includes an electrical connector 554 that is attached to ribbon cable 526. A user can install or mount the brake cartridge onto power tool 510 by sliding the cartridge onto the mounting pins. In the exemplary embodiment, a locking component 556 in the form of a key is used to secure the brake cartridge to the power tool. Conversely, a user can uninstall the brake cartridge from the power tool by removing the key and then sliding the cartridge off the mounting pins.

When a user of power tool 510 installs brake cartridge 524 onto mounting pins 552, a matching connector on the brake cartridge engages and connects to connector 554. As a result, when the brake cartridge is mounted to cartridge bracket 550, it becomes a component of control system 516 and control circuit 518. Electrical power can be supplied to the processor in brake cartridge 524 via ribbon cable 526, enabling the processor to function. When the power tool control system is turned on by the user, by plugging in an electrical cord and/or turning a main power switch to ON, the processors in the switchbox and brake cartridge initialize and begin operating according to the software stored within the processors. The processor in switchbox 548 is programmed with stored digital information identifying the type of power tool 510 and communicates this information to the processor in brake cartridge 524, which is configured to receive the information. Based on the type of power tool 510, the processor in the brake cartridge operates according to that portion of its stored software configured for power tools of such type. Accordingly, the brake cartridge processor is able to correctly monitor and/or control one or more of the conditions and functions associated with the type of power tool of which power tool 510 is a member. In the exemplary embodiment, the brake cartridge processor is coupled to the blade through the arbor and configured to detect if a person contacts the blade when it is moving. In the event such a dangerous condition is detected, the brake cartridge processor is configured to activate an electronic switch inside the brake cartridge which conducts electrical current to melt a fuse wire. When the fuse wire melts, a spring is released to push brake pawl 528 into the teeth of blade 512, thereby stopping the blade.

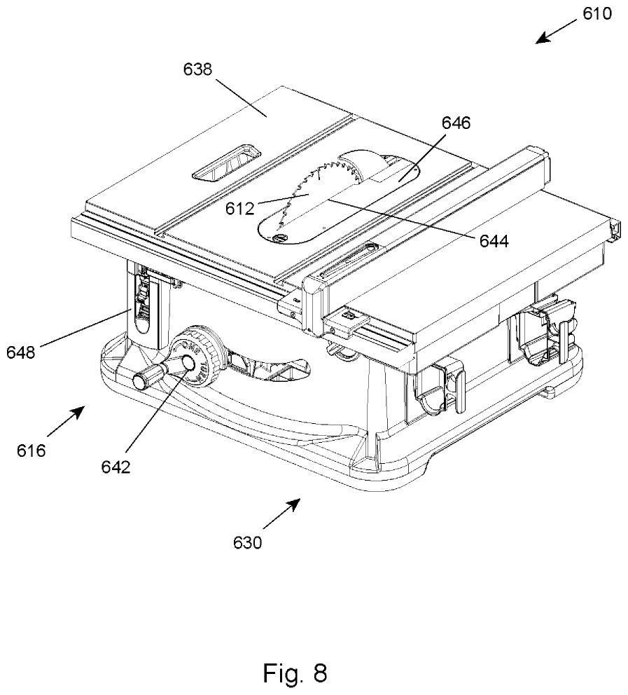

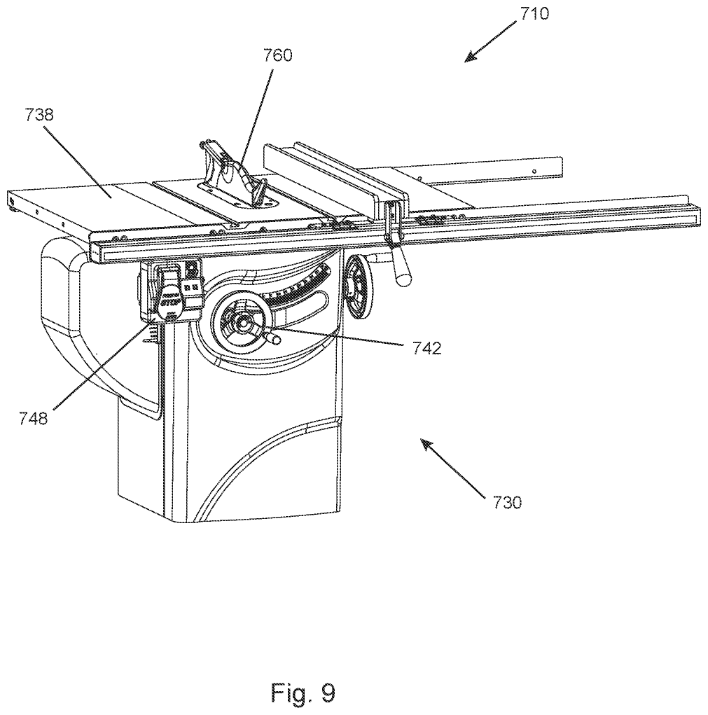

It will be appreciated that since brake cartridge 524 can be uninstalled from power tool 510, it can then be installed by the user onto another power tool that is the same type as power tool 510. Alternatively, the brake cartridge can be uninstalled from power tool 510 and then installed on a different type of power tool that is configured to accept and connect to the brake cartridge. Examples of such other types of power tools are shown in FIGS. 8 and 9.

Turning attention first to FIG. 8, a power tool in the form of a transportable, jobsite table saw is shown and indicated generally at 610. Table saw 610 includes a support structure 630 in the form of a plastic housing that substantially encloses the internal mechanism of the saw. Table saw 610 also includes a die-cast aluminum table that is mounted to, and supported by, the support structure. The table saw includes a universal motor (not shown) that is mounted to a trunnion assembly within the housing. A circular saw blade 612 is mounted to an arbor that is driven by the motor via a belt that connects the motor to the arbor. The trunnion assembly includes one or more controls such as handwheel 642 which can be operated by a user to adjust the position of the blade relative to the table. As with many table saws, the user adjusts the blade to protrude partially above the table to cut workpieces placed on the table. The blade protrudes through a slot 644 in a table insert 646.

As with power tool 510, power tool 610 includes a control system, indicated generally at 616, with AIM technology. Control system 616 includes a control circuit with a switchbox 648 which is mounted to the housing. The control system includes a first processor (not shown) that is located inside the switchbox. The control system also includes a replaceable module in the form of brake cartridge 524. Table saw 610 includes a cartridge bracket with mounting pins to accept the brake cartridge, as well as a connector configured to connect to the brake cartridge. An electrical cable runs from the connector to switchbox 648, to supply electrical power to the processor in the brake cartridge, and to allow the processors in the switchbox and brake cartridge to communicate. Thus, the brake cartridge becomes a part of control system 648 when the cartridge is installed on table saw 610. The processor in the switchbox is programmed to store information identifying the type of power tool of which table saw 610 is a member. The switchbox processor can thereby communicate this identifying information to the cartridge processor, enabling the cartridge processor to operate according to its software when installed in a table saw of the type embodied by table saw 610.

Turning now to FIG. 9 another example of a power tool is shown, indicated generally at 710. Power tool 710 is in the form of a stationary table saw with a support structure that includes a metal cabinet 730. Table saw 710 also includes a cast-iron table 738 that is mounted to, and supported by, the cabinet. The exemplary table saw of FIG. 9 also includes a circular saw blade that is shown enclosed by a movable blade guard 760, and that is mounted to an arbor that is belt-driven by an induction motor within the cabinet. Table saw 710 also includes a trunnion assembly inside the cabinet which is mounted to the cabinet, and which is configured to support and adjust the position of the blade relative to the table through the operator's use of control components such as handwheel 742. It will be appreciated that, unlike table saws 510 and 610, table saw 710 is a very large and heavy machine that is not intended to be transportable without special equipment such as mobile bases, forklifts, etc.

It will be appreciated that table saw 710 is another member of a set of power tools according the present invention, that also includes table saws 510 and 610. Thus, table saw 710 also includes a control system such as described above. The control system of table saw 710 includes a switchbox 748 with a first processor as described above. Additionally, the control system includes an electrical cable to connect to brake cartridge 524 when the cartridge is installed on a cartridge bracket that is a component of the trunnion assembly of table saw 710. The switchbox processor is programmed with stored data to identify the type of power tool 710, and to communicate this information to the processor in the brake cartridge. Once the cartridge processor receives the information identifying the type of power tool it is installed in, the processor can operate as configured when installed in such a power tool.

As described above, table saws 510, 610 and 710 form a system or set of different types of power tools, each of which includes a different type of control system with a different control circuit including a processor that is configured specifically for the type of power tool of which the corresponding control system is a part. But each type of control system is configured to utilize a common replaceable module which can be selectively installed on, and uninstalled from, each of the power tools by a user or operator. The common replaceable module can also be thought of as a universal, or generic, or system-compatible replaceable module. In any event, once the common replaceable module is installed on any one of the power tools, the switchbox processor that is specifically configured for the particular power tool communicates the type of the particular power tool to the processor in the replaceable module. This enables the processor in the replaceable module to function as an operable part of the corresponding control system by executing the portion of the software stored by the processor in the replaceable module that is configured specifically for that particular power tool. Furthermore, the replaceable module may be uninstalled by an operator from one type of power tool and then installed on a different type of power tool within the set of different types of power tools, at which point the processor in the replaceable module will be enabled to function as an operable part of the new power tool control system. In other words, the processor in the replaceable module will be enabled, by receiving information that identifies the particular power tool, to function differently depending on which type of power tool the replaceable module is installed within.

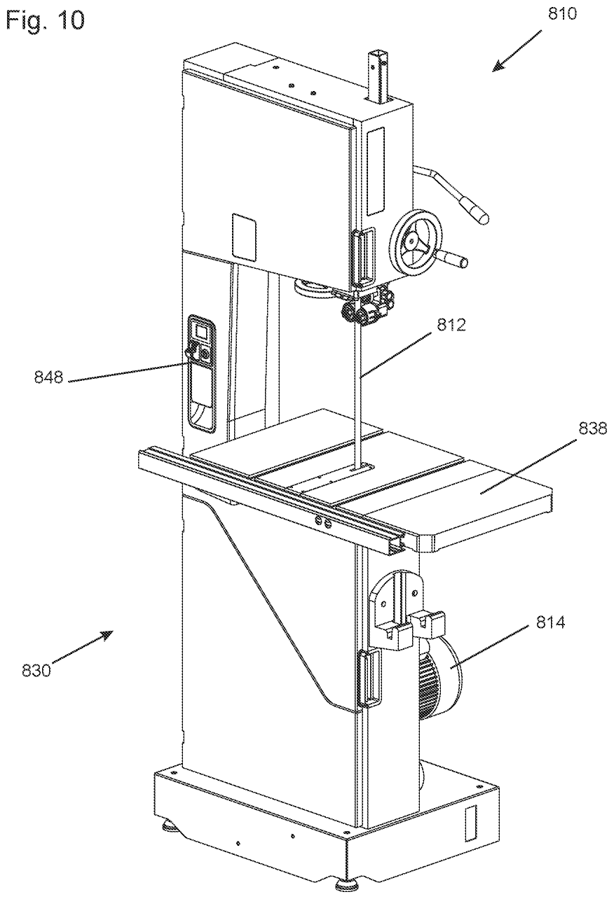

Turning attention now to FIG. 10, another exemplary power tool within the scope of the present invention is shown indicated generally at 810 in the form of a band saw. Band saw 810 includes a cutter 812 in the form of a toothed band that is belt-driven by an induction motor 814. Band saw 812 also includes a support structure 830 in the form of a metal cabinet that supports the motor and internal assembly. The exemplary band saw also includes a cast-iron table 838 mounted to the cabinet, and through which the cutter passes. Band saw 810 includes a control system with a switchbox 848 that is mounted to the cabinet. The control system also includes a replaceable module or cartridge with a processor configured to connect to the control system so as to become an operable part of the control system. A processor in the switchbox is programmed to store information identifying the type of power tool of which band saw 810 is a specimen. The switchbox processor is configured to communicate the identifying information to the replaceable module processor, thereby enabling the replaceable module processor to operate according to that portion of its stored software that is configured for the particular band saw.

As is well-known to those of skill in the art, band saws are available in many different sizes and with many different features and combinations of features. Thus, there are different types of band saws with different functions and conditions. Each different type of band saw will typically have a different type of control system to monitor and control the corresponding functions and conditions. Therefore, a replaceable module that is configured to function as an operable component of multiple different types of control systems, such as has been described above, can offer many advantages. Moreover, it will be appreciated that the advantages of a replaceable module are especially realized for band saws with control systems that include AIM technology. In one exemplary embodiment, a common replaceable module for a set of different types of bandsaws includes a reaction mechanism to stop the band saw cutter from cutting if the detection system in the control system detects accidental contact between a person and the cutter when the cutter is moving. Alternatively, or additionally, such a replaceable module for a set of different types of band saws could be configured to provide any of the other advantages of replaceable modules as have been described above.

It will be appreciated that the control systems described herein may be implemented on many different types of power tools in addition to the table saws and band saws described above. Examples of such other power tools include jointers, routers, hand-held circular saws, miter saws, shapers, upcut saws, and etc. It will also be appreciated that control systems for such different types of power tools may be configured, within the scope of the present invention, to utilize replaceable modules that are specific to one category of power tools or to multiple categories of power tools. In other words, a replaceable module may be common to different types of table saws only, or a replaceable module may be common to different types of table saws and band saws. Similarly, sets of different types of miter saws may utilize a replaceable module that is also common to one or more different types of hand-held circular saws. Thus, the scope of the present invention is not limited to the specific exemplary embodiments described herein but includes all such alternatives and combinations.

### INDUSTRIAL APPLICABILITY

The control systems and methods disclosed herein are applicable to power tools, and specifically to power tools equipped with active injury mitigation technology. Various disclosed features are particularly applicable to a set, collection, family, series, group or suite of different types of power tools.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. No single feature, function, element or property of the disclosed embodiments is essential to all of the disclosed inventions. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

1. A power tool, comprising:
a support structure;
a cutter supported by the support structure and adapted to cut a workpiece when moving;
a motor supported by the support structure and configured to move the cutter; and
a control system configured to control at least one function of the power tool and including a control circuit supported by the support structure, where the control circuit includes a first processor with information identifying the power tool;
where the support structure includes a mounting component adapted to receive and support a replaceable module installed by an operator of the power tool, the replaceable module including a second processor;
where the control circuit is configured to operably connect to the second processor when an operator of the power tool installs the replaceable module on the mounting component; and
where the first processor is configured to communicate the information identifying the power tool to the second processor when the control circuit is operably connected to the second processor.

2. The power tool of claim 1, where the operation of the second processor is at least partially responsive to the information identifying the power tool.

3. The power tool of claim 1, where the control system is configured to control at least one function of the power tool in response to an output from the second processor when the control circuit is operably connected to the second processor.

4. The power tool of claim 2, where the control system is configured to stop the motor in response to an output from the second processor.

5. A set of power tools, comprising:
a first power tool operable by a person to cut workpieces, where the first power tool includes,
a first support structure,
a first movable cutter supported by the first support structure and adapted to cut workpieces when moving,
a first motor supported by the first support structure and configured to move the first cutter, and
a first control circuit supported by the first support structure and having a first processor configured to control at least one function of the first power tool;
a second power tool operable by a person to cut workpieces, where the second power tool includes,
a second support structure,
a second movable cutter supported by the second support structure and adapted to cut workpieces when moving,
a second motor supported by the second support structure and configured to move the second cutter,
a second control circuit supported by the second support structure and having a second processor configured to control at least one function of the second power tool; and
a control module selectively mountable to either the first support structure or the second support structure, where the control module includes a third processor configured to connect to the first control circuit and communicate with the first processor when the control module is mounted to the first support structure, and where the third processor is configured to connect to the second control circuit and communicate with the second processor when the control module is mounted to the second support structure;
where the first processor is programmed with first stored information identifying the first power tool, and where the first processor is configured to communicate the first stored information to the third processor when the third processor is connected to the first control circuit;
where the second processor is programmed with second stored information identifying the second power tool, and where the second processor is configured to communicate the second stored information to the third processor when the third processor is connected to the second control circuit; and
where the third processor is configured to control at least one function of the first power tool when the third processor is connected to the first control circuit, and to control at least one function of the second power tool when the third processor is connected to the second control circuit.

6. The set of power tools of claim 5, where the operation of the third processor is at least partially responsive to the first stored information when the third processor is connected to the first control circuit, and where the operation of the third processor is at least partially responsive to the second stored information when the third processor is connected to the second control circuit.

7. The set of power tools of claim 5, where the first control circuit includes a first electrical switch adapted to supply electrical power to the first motor, and where the second control circuit includes a second electrical switch adapted to supply electrical power to the second motor, and where the first electrical switch is adapted to supply at least one of a higher voltage or a higher current than the second electrical switch is adapted to supply.

8. The set of power tools of claim 5, where the first motor is configured to rotate at a different speed than the second motor.

9. The set of power tools of claim 5, where the first power tool includes a first workpiece support surface constructed substantially of cast iron, and where the second power tool includes a second workpiece support surface constructed substantially of aluminum.
